(19) United States
(12) Patent Application Publication
(10) Pub. No.: US 2004/0030053 A1
(43) Pub. Date: Feb. 12, 2004

(54) Processes for production of surface-modified rubbers

(76) Inventors: Ryuji Izumoto, Tokyo (JP); Mitsuaki Maeda, Tokyo (JP); Yasuo Horikawa, Tokyo (JP)

Correspondence Address: SUGHRUE MION, PLLC, 2100 PENNSYLVANIA AVENUE, N.W., WASHINGTON, DC, 20037, US

(21) Appl. No.: 10/416,448

(22) PCT Filed: Nov. 12, 2001
(86) PCT No.: PCT/JP01/09873

(30) Foreign Application Priority Data
Nov. 13, 2000 (JP) 2000345681
Nov. 15, 2000 (JP) 2000348579

(51) Int. Cl. B32B 7/00

(52) U.S. Cl. 525/326.1; 428/402; 428/403

(57) ABSTRACT

The present invention provides a process for producing surface-modified rubber that is useful as a recycled material having characteristics inherent in vulcanized rubber, wherein the surface-modified rubber is obtained in such a manner that waste vulcanized rubber resulting from scrap tires and so on is dipped in a silane-coupling agent diluted with a solvent to improve the adhesiveness of the rubber surface. Such a silane-coupling agent preferably has a mercapto group or an S—S bond and is used in such a manner that the agent is diluted so as to have a content of 0.5 to 5%. Furthermore, the present invention provides a process for producing surface-modified rubber, obtained by modifying the surface of vulcanized rubber by corona discharge treatment or the like, having a contact angle of 80 degrees or less. In this process, it is preferable that the vulcanized rubber is further treated with a silane-coupling agent.

### TECHNICAL FIELD

The present invention relates to the improvement of the surface adhesiveness and durability of waste rubber. The present invention particularly relates to a process for producing surface-modified rubber (hereinafter simply referred to as “modified rubber”) having surface adhesiveness and durability improved by surface treatment, and also relates to an elastic form, a tire formulation, a paving material, and a paving course each containing the surface-modified rubber.

The present invention relates to processes for efficiently recycling materials such as waste vulcanized rubber resulting from used tires and so on. The present invention particularly relates to a process for producing surface-modified rubber from such waste vulcanized rubber and also relates to a paving material, a paving course, an elastic form, and a tire formulation each containing the surface-modified rubber.

### BACKGROUND ART

Various recycling systems, which concern techniques for efficiently reusing or recovering waste vulcanized rubber resulting from scrap tires and so on, have been conventionally proposed. Such systems for recycling such waste rubber include (1) a thermal recycling system (fuel use for firing cement), (2) a reuse (recapped tires) system, (3) a material recycling system (the recycling of reclaimed rubber, which is pulverized and then vulcanized according to needs, into new tires; low noise-type elastic pavement containing rubber chips; and so on), (4) a chemical recycling system (the recycling of vulcanized rubber into raw materials such as non-vulcanized rubber and oil by treating the vulcanized rubber), and so on.

Among these recycling systems, the thermal recycling system for providing fuel is the most popular. In recent years, waste rubber-recycling systems for not providing fuel but providing material have been researched. However, commercially viable systems have not been developed, because it is difficult to provide recapped tires having performance equivalent to that of new tires, while the chemical recycling systems has been recently being developed. Under such circumstances, expectations on the material-recycling system are currently growing.

The material-recycling system includes the following processes for improving product performance by desulfurization treatment: (1) a reclaiming process (a process for providing tires by recycling, the process being in a domestic dominant position), (2) a shearing process (a process disclosed in many patent applications, recently applied, including Japanese Unexamined Patent Application Publication No. 9-227724, Japanese Unexamined Patent Application Publication No. 2000-128901, and so on), (3) a microwave process (a process disclosed in Japanese Unexamined Patent Application Publication No. 5-133514 and so on), (4) a ultrasonic process (a process disclosed in PCT Japanese Translation Patent Publication No. 8-501258 and so on), and so on. Furthermore, the material-recycling system includes the following pavement and process in which vulcanized rubber processed into fine powder or chips by a thermal decomposition method, a room-temperature crushing method, a freeze-crushing method, and so on is used in combination with rubber: (1) low noise-type elastic pavement (pavement, disclosed in Japanese Patent No. 2869459, Japanese Patent No. 2869458, and so on, containing an urethane or epoxy resin functioning as an adhesive binder), (2) a process for recycling powdery rubber having a small particle size into tires (a process for providing tires by recycling, the process being in a dominant position in the United State and disclosed in Japanese Unexamined Patent Application Publication No. 10-128752), and so on. Furthermore, the material-recycling system includes the following processes for molding waste vulcanized rubber into one piece to provide molded forms: (1) an one-piece molding process using a binder such as a urethane resin, concrete, or mortar (a process disclosed in Japanese Unexamined Patent Application Publication No. 2000-43069, Japanese Unexamined Utility Model Registration Application Publication No. 56-57330, and Japanese Unexamined Utility Model Registration Application Publication No. 7-1046), (2) a rubber chip contact-molding process (a process disclosed in Japanese Unexamined Patent Application Publication No. 6-270151), and so on.

In general, waste vulcanized rubber obtained from scrap tires and the like has weak adhesiveness. Therefore, when such rubber is recycled into raw materials, in the above recycling systems, the following processes are employed: a modifying process including desulfurization treatment such as shearing treatment; a process for mixing a thermoplastic material and the waste rubber; a process including the steps of mixing a molten thermoplastic material and the waste rubber, cooling the mixture, and then mixing the mixture with new rubber and a vulcanizing agent to form a sheet; and so on. For an elastic use, the following process is mainly employed: a process in which the waste rubber is bound with a binder and the bound rubber is formed into blocks. In these processes, the waste rubber itself is not treated, for example, is not surface-treated. The waste rubber is modified in an untreated state or modified by mixing treatment.

On the other hand, in order to process and/or in order to process and modify the waste vulcanized rubber, processes in which a reclaiming agent or a chemical agent is added to the waste rubber are employed. Such processes using the latter agent includes, for example, (1) a process including the steps of mixing the waste rubber with a hot melt adhesive, cooling the mixture, further mixing the resulting mixture with non-vulcanized rubber and a vulcanizing agent, and then forming sheets or plates; (2) a process using oil, an organic solvent, and a peptizer; (3) a process for mixing powdery rubber with trisamine to improve the curing properties; (4) a process using a desulfurization agent reacting with a SOₓ gas; and so on.

Since rubber obtained from the waste vulcanized rubber is inherently an inexpensive material, such rubber can be effectively used if the rubber can be commercialized in order to reduce processing cost. However, in the conventional recycling systems, products having limited applications are only obtained due high cost.

That is, the material recycling system including desulfurization treatment is effective. However, there is a problem in that a large quantity of energy is required in processing steps because the waste rubber must be desulfurized as completely as possible in order that the waste rubber is recycled into tires and so on. Furthermore, there is a problem in that products manufactured by conventional desulfurization processes are not eligible for a recycling use in which their properties, such as elasticity, inherent in vulcanized rubber can be exerted.

When chips or powder of vulcanized rubber is used, the biggest challenge is how to increase the surface adhesiveness of the vulcanized rubber. In particular, when the chips are used, it is impossible to obtain composites having sufficiently high quality and it is difficult to join the untreated rubber chips each other because the waste rubber chips contain various types of rubber. However, in this regard, processes for recycling untreated vulcanized rubber have not sufficiently developed as compared with the above desulfurization treatment. For example, in the paving industry in which research and development has been recently advanced, a technique using a curable binder such as an urethane resin or an epoxy resin has been established. However, sufficient adhesiveness has not been achieved. Furthermore, there is a problem in that the applicability is limited because such a special binder is used. When used paving materials are recycled, there is a problem in that the curable binder functions as an impurity to cause negative effects on the recycling. Furthermore, it is difficult to apply this technique to tires because binders for paving materials cannot be used for a fresh rubber matrix.

Furthermore, when vulcanized rubber particles are simply compacted, the vulcanized rubber particles cannot be sufficiently joined each other and therefore compact forms have insufficient performance.

Accordingly, it is an object of the present invention to provide a process for producing surface-modified rubber, into which waste vulcanized rubber can be recycled and in which raw material properties are maintained, having inexpensiveness inherent in the waste vulcanized rubber and also provide an elastic form, a tire formulation, a paving material, and a paved body each containing the surface-modified rubber.

Furthermore, it is another object of the present invention to provide a process for process for producing surface-modified rubber from vulcanized rubber by providing surface adhesiveness to the waste vulcanized rubber and also provide an elastic form, a tire formulation, a paving material, and a paved body each containing the surface-modified rubber, wherein the surface-modified rubber has inexpensiveness inherent in the waste vulcanized rubber and can be recycled in various applications.

### DISCLOSURE OF INVENTION

In order to solve the above problems, the inventors have intensively conducted research on the process and/or modification of waste vulcanized rubber and particularly conducted research on the surface treatment thereof. As a result, the inventors found that the waste vulcanized rubber can be recycled into recycling materials having characteristics inherent in vulcanized rubber in such a manner that the waste vulcanized rubber is surface-treated with a specific solvent to improve the adhesiveness of the rubber surface and the material durability. Thereby, the present invention was completed.

The present invention provides a process for producing surface-modified rubber including a step of dipping waste vulcanized rubber in a silane-coupling agent diluted with a solvent.

The content of the diluted silane-coupling agent is preferably 0.5 to 5%, and the silane-coupling agent preferably has a mercapto group or an S—S bond.

Furthermore, an elastic form of the present invention is manufactured by molding surface-modified rubber, produced by the above production process, into one piece by heat compression. A tire formulation of the present invention contains powdery surface-modified rubber dispersed in fresh rubber, wherein the powdery surface-modified rubber, produced by the above production process, has a particle size of 1 μm to 3 mm.

A paving material of the present invention contains a hard aggregate, an elastic aggregate, and a binder, wherein the elastic aggregate contains surface-modified rubber, produced by the above production process, having a particle size of 10 μm to 20 mm. A paving course of the present invention contains a hard aggregate, an elastic aggregate, and a binder, wherein the elastic aggregate contains surface-modified rubber, produced by the above production process, having a particle size of 10 μm to 20 mm.

In order to solve the above problems, the present invention provides a process for producing surface-modified rubber including a step of modifying the surface of vulcanized rubber such that the surface has a contact angle of 80 degrees or less.

The surface-modifying step preferably includes the corona discharge treatment of the vulcanized rubber surface. The production process further includes a step of treating the vulcanized rubber surface, surface-modified in the surface-modifying step, with a silane-coupling agent.

Furthermore, a paving material of the present invention contains a binder, an aggregate, and surface-modified rubber, produced by the above process, having a particle size of 10 μm to 20 mm. A paving course of the present invention contains a binder, an aggregate, and surface-modified rubber, produced by the above production process, having a particle size of 10 μm to 20 mm.

An elastic form of the present invention is manufactured by molding surface-modified rubber, produced by the above production process, into one piece by heat compression. A tire formulation of the present invention contains powdery surface-modified rubber dispersed in fresh rubber, wherein the powdery surface-modified rubber, produced by the above production process, has a particle size of 1 μm to 3 mm.

### BEST MODE FOR CARRYING OUT THE INVENTION

Particular embodiments of the present invention will now be described in detail.

In the present invention, it is important that a process for producing surface-modified rubber includes a step of dipping waste vulcanized rubber, obtained from scrap tires and the like, in a silane-coupling agent diluted with a solvent, and other production conditions are not particularly limited. The waste vulcanized rubber is treated with the diluted silane-coupling agent and then dried at high temperature, thereby obtaining surface-modified rubber according to the present invention. When such surface-modified rubber is bound with, for example, a one or two-part urethane binder, the resulting surface-modified rubber can be recycled into a raw material. Thereby, the surface-modified rubber is greatly improved in adhesiveness in an initial state and the surface-modified rubber subjected to a degradation test in water is also improved in adhesiveness as compared with rubber that is not surface-modified.

Vulcanized rubber that can be used in a production process of the present invention is not particularly limited, and such vulcanized rubber is obtained in such a manner that sulfur or a sulfur compound added to a polymer to form various sulfur-crosslinking bonds such as a monosulfide bond, a disulfide bond, and a polysulfide bond. Thereby, the resulting polymer has rubber elasticity.

Such a polymer includes natural rubber, butadiene rubber, isoprene rubber, butyl rubber, ethylene-propylene rubber, styrene-butadiene rubber, EPDM (ethylene-propylene dien terpolymer), acrylic rubber, acrylonitrile-butadiene rubber, and so on.

Such waste vulcanized rubber can be obtained from rubber tires, weather strips, scrap materials such as spent hoses, unnecessary chips resulting during molding, defective forms, and so on.

The silane-coupling agent used herein is not particularly limited and preferably has a mercapto group or an S—S bond. The silane-coupling agent includes, for example, mercaptopropylsilane, glycidoxypropylsilane, aminopropylsilane, and so on. The content of the diluted coupling agent is preferably 0.5 to 5%, and more preferably 1 to 3%. A dilution solvent is not particularly limited and includes, for example, ethyl acetate. Preferable drying conditions of the rubber dipped in the coupling agent are as follows: a temperature of 100 to 150° C. and a time of 5 to 60 minutes in the case of high-temperature, and a temperature of 20 to 40° C. and a time of 24 to 96 hours in the case of low-temperature.

As described above, modified rubber obtained by the production process of the present invention is improved in surface adhesiveness at low cost in a simple manner as compared with conventional one. Therefore, such rubber can be used in various applications because of its inexpensiveness and elastic properties. For example, rubber particles can be securely joined to each other by heat compression and then molded into one piece, thereby obtaining an elastic form. Such an elastic form can be used for, for example, elastic tile, tennis courts, athletic fields, sidewalks, and so on.

Modified rubber according to the present invention can be preferably used for a tire formulation and a paving material or a paving course for elastic pavement such as a tennis court, an outdoor training field, and a sidewalk. As described above, in the present invention, rubber can be improved in adhesiveness by a factor of 1.5 to 5 as compared with untreated one (which is not treated) and improved in elastic property. Therefore, such rubber can be preferably used for tire formulations and can be also preferably used for paving materials for roads when a binder is used.

Such a tire formulation contains powdery surface-modified rubber, dispersed in fresh rubber, according to the present invention, wherein the powdery surface-modified rubber has a particle size of 1 μn to 3 mm. When the particle size is less than 1 μm, size-reducing treatment including freeze crashing and so on is necessary and therefore manufacturing cost is increased. Thus, such a size is not preferable. In contrast, when the particle size is more than 3 mm, the modified rubber has such a small surface area per unit area that adhesiveness sufficient for tire applications cannot be obtained. Thus, such a size is not preferable.

In general, in order to reduce tire noise, paving materials and paving courses for elastic pavement have porous structure having a ventilating function and a sound absorbing function, and therefore such paving materials and courses contain a hard aggregate, an elastic aggregate, and a binder. In the present invention, the elastic aggregate includes surface-modified rubber, manufactured by a production process of the present invention, having a particle size of 10 μm to 20 mm. When the particle size is less than 10 μm, the paving materials cannot have elastic properties inherent in crosslinked rubber and therefore noise cannot be reduced. Thus, such a size is not preferable. In contrast, when the particle size is more than 20 mm, the specific surface area is too small to obtain adhesiveness sufficient for paving applications. Thus, such a size is not preferable. The content of each component may be determined by a conventional method according to needs and is not particularly limited. The blending rate of the binder to the modified rubber of the present invention is preferably 15 to 30% by volume, and more preferably 20 to 25% by volume. When the blending rate exceeds 30% by volume, loss is caused due to precipitation. In contrast, when the blending rate is less than 15% by volume, it takes long time to cover the rubber chip surface with the binder during mixing and unevenness in covering arises, thereby causing uneven adhesion.

The binder used for a paving material and a paving course of the present invention includes, for example, asphalt, urethane, epoxy, and so on and is not particularly limited.

In general, the hard aggregate includes, for example, natural aggregates including natural stones, such as river gravel and river sand, and artificial aggregates including crushed stones, slugs, and ceramics and is not particularly limited. Stone, sand, and so on used for the aggregate provide strength and abrasion resistance to finished pavement and are disposed on the surface so as to prevent slipping. The stone preferably have a function of distributing a load in such a manner that stones are engaged each other. Therefore, crushed stones having an irregular shape and high hardness are suitable. Coarse aggregates having a particle size of 0.5 to 30 mm are preferably mixed with 5% by volume of fine aggregates having a particle size of 0.5 mm or less with respect to the coarse aggregates. The coarse aggregates principally function so as to form porous structure to provide permeability. Therefore, the coarse aggregates preferably have an irregular shape and high hardness so as to provide cavities in such a manner that the coarse aggregates are engaged each other. On the other hand, the fine aggregates adhere to the coarse aggregates having a large particle size to provide a slip-preventing effect (a grinding effect of sandpaper) to tires and so on.

The paving material or the paving course is prepared according to the following procedure: the hard aggregates and the elastic aggregates are mixed together, an additive such as a coloring agent is added to the mixture according to needs during mixing, a binder is then added to the resulting mixture to prepare the paving material or a compound for the paving course. For example, the paving course compound is poured into a mold and then heated according to needs, and the resulting compound is removed from the mold, thereby obtaining the paving course.

Next, other embodiments of the present invention will now be described in detail.

In the present invention, it is important that a process for producing surface-modified rubber includes a step of modifying the surface of vulcanized rubber such that the surface has a contact angle of 80 degrees or less. Ordinary vulcanized rubber has a contact angle of 100 to 110 degrees. The value of the contact angle represents the degree of affinity of the vulcanized rubber with respect to water. Thus, as the contact angle is smaller, the affinity to water is higher, that is, the vulcanized rubber has hydrophilicity. Accordingly, the vulcanized rubber preferably has a contact angle of 80 degrees or less, more preferably 70 degrees or less, and further more preferably 60 degrees or less. Since the surface has such high hydrophilicity, the surface can securely adhere to urethane and epoxy compounds having hydrophilic groups. Thus, waste vulcanized rubber can be greatly improved in surface adhesiveness, and therefore such waste vulcanized rubber has adhesiveness higher than ever.

In the present invention, a surface-modifying method is not particularly limited as long as the surface has a contact angle of 80 degrees or less. The rubber surface is preferably corona-treated so as to have a desired contact angle. That is, when vulcanized rubber surface is corona-treated in an air atmosphere, hydrophilic functional groups such as a OH group and a COOH group can be introduced into molecular chains disposed on the rubber surface, thereby improving the surface hydrophilicity. Thus, the above-mentioned contact angle can be obtained.

In the corona discharge treatment, the electric power consumption per centimeter is 0.5 to 50 W. preferably 1 to 40 W, and more preferably 3 to 30 W. When the consumption is less than 0.5 W. the intensity of the corona discharge treatment is too weak to introduce the hydrophilic groups in a sufficient amount. In contrast, when the consumption is more than 50 W, the intensity of the corona discharge treatment is too strong and therefore the vulcanized rubber is deteriorated, thereby causing reduction in performance.

In the corona discharge treatment, the treating time for each time is 5 seconds to 5 minutes and preferably 10 seconds to 3 minutes. When the treating time is less than 5 minutes, the hydrophilic groups cannot be introduce in a sufficient amount. In contrast, when the treating time is more than 5 minutes, the vulcanized rubber is deteriorated due to heat generated during the treatment, even if the electric power consumption is within the above range.

It is preferable to repeatedly perform the corona discharge treatment a plurality of times, because the rubber surface can be uniformly treated and the hydrophilicity of the rubber surface can be maintained even if time has passed. Sufficient effects can be obtained even if the treatment is performed once. Higher effects can be obtained if the treatment is performed twice to four times. However, further higher effects cannot be obtained if the treatment is performed five or more times.

In the present invention, the reaction of the hydrophilic groups is then performed within 24 hours, preferably within 10 hours, and more preferably within 8 hours after the corona discharge treatment is performed. The hydrophilic groups on the rubber surface tend to migrate into the rubber, with the passage of time, because of the Brownian movement of the molecular chains. Thus, in order to effectively perform the reaction of the hydrophilic groups, such time management is necessary.

The waste vulcanized rubber used in the present invention is not limited to a particular type and includes natural rubber, isoprene rubber, styrene-butadiene rubber, butyl rubber, ethylene-propylene rubber, and so on.

In a production process of the present invention, the vulcanized rubber surface treated so as to have a contact angle of 80 degrees or less is preferably further treated with a silane-coupling agent. Since the hydrophilic groups disposed on the rubber surface readily react with the silane-coupling agent, such treatment provides a configuration in which the silane-coupling agent is arranged on the vulcanized rubber surface in a bonded manner. Thereby, the waste vulcanized rubber can be allowed to bond to various materials using the adhesive reaction of the silane-coupling agent. If the corona discharge treatment according to the present invention is not performed, the silane-coupling agent can bond to the vulcanized rubber surface to a certain extent. However, in this case, a large quantity of the silane-coupling agent is necessary, the treating time is long, and a small amount of the silane-coupling agent is provided to the rubber surface by the treatment. Thus, when the treatment with the silane-coupling agent is performed in addition to the corona discharge treatment, extremely high advantages can be obtained.

In general, since the silane-coupling agent has high reactivity and affinity with respect to the hydrophilic groups, the silane-coupling agent is not limited to a particular type. In particular, it is advantageous that the silane-coupling agent having an S—S bond therein is used when the waste vulcanized rubber is joined to unvulcanized rubber containing sulfur. Since the S—S bond of the silane-coupling agent contributes to the crosslinking reaction during the vulcanization of the unvulcanized rubber, high adhesive advantages can be obtained.

Since surface-modified rubber produced by a production process of the present invention has superior adhesiveness, as described above, such surface-modified rubber can be used in various applications because of its inexpensiveness and elastic properties. For example, when the surface-modified rubber is used together with a binder and an aggregate, a paving material and a paving course can be obtained. Such a paving material and course containing the modified rubber according to the present invention can reduce noise because of the elastic properties as compared with conventional pavement. When the paving material and course contain untreated waste rubber, there is a problem in durability, that is, the rubber is removed by cars running thereon because the rubber surface has not sufficient adhesiveness. When the waste rubber is surface-modified by a method of the present invention, the rubber surface can be improved in adhesiveness, thereby obtaining the paving material containing waste rubber having high durability.

The particle size of the modified rubber is 10 μm to 20 mm, and preferably 50 μm to 15 mm. When the particle size is less than 10 μm, elastic advantages provided by the vulcanized rubber is insufficient and therefore noise cannot be sufficiently reduced by the added rubber. In contrast, when the particle size is more than 20 mm, the vulcanized rubber has a surface area that is too small to sufficiently improve the adhesiveness according to the present invention when the rubber is used in paving applications. The content of each component may be determined by a conventional method according to needs and is not particularly limited. The blending rate of the binder with respect to the modified rubber according to the present invention is preferably 15 to 30% by volume, and more preferably 20 to 25% by volume. When the blending rate is more than 30% by volume, precipitation arises to cause loss. In contrast, when the blending rate is less than 15% by volume, it takes long time to cover the rubber surface with the binder during mixing and unevenness in covering arises, thereby causing uneven adhesion.

The binder used for the paving material and the paving course include asphalt, asphalt emulsion, one-part urethane, two-part urethane, epoxy, and so on. For the asphalt, modified asphalt containing an elastomer is preferably used, thereby obtaining high durability resulting from the adhesive reaction between the elastomer and the modified vulcanized rubber. For the modified asphalt, in particular, a high-viscosity binder type used for permeable pavement and so on is preferable because the elastomer content is high. Since urethane and epoxy binders have extremely high reactivity with respect to hydrophilic groups, such binders are securely joined to the corona-treated vulcanized rubber, thereby obtaining high advantages.

The aggregate is not particularly limited and includes natural aggregates such as river gravel and river sand, and recycled aggregates such as crushed stones, slugs, concrete, glass, FRPs. Stone, sand, and so on used for the aggregate provide strength and abrasion resistance to finished pavement and are disposed on the surface so as to prevent slipping. The stone preferably have a function of distributing a load in such a manner that stones are engaged each other. Therefore, crushed stones having an irregular shape and high hardness are suitable. Coarse aggregates having a particle size of 0.5 to 30 mm are preferably mixed with 5% by volume or more of fine aggregates having a particle size of 0.5 mm or less with respect to the coarse aggregates. The coarse aggregates principally function so as to form porous structure to provide permeability. Therefore, the coarse aggregates preferably have an irregular shape and high hardness so as to provide cavities in such a manner that the coarse aggregates are engaged each other. On the other hand, the fine aggregates adhere to the coarse aggregates having a large particle size to provide a slip-preventing effect (a grinding effect of sandpaper) to tires and so on. Modified rubber treated with a silane-coupling agent according to the present invention is preferable, because such modified rubber can be joined to not only the above binder but also the aggregate.

The paving material or the paving course is prepared according to the following procedure: the aggregate and the modified rubber are mixed together, an additive such as a coloring agent is added to the mixture according to needs during mixing, a binder is then added to the resulting mixture to prepare a compound for the paving material or the paving course. For example, the paving course compound is poured into a mold and then heated according to needs, and the resulting compound is removed from the mold, thereby obtaining the paving course.

In surface-modified rubber produced by performing the treatment with a silane-coupling agent according to the present invention, rubber particles can be securely joined to each other by heat compression and then molded into one piece, thereby obtaining an elastic form. Such an elastic form can be used for, for example, elastic tile, tennis courts, athletic fields, sidewalks, and so on. A processing apparatus is not particularly limited and includes a press and so on. Modified rubber that is not treated with the silane-coupling agent but only corona-treated does not lend itself to this application. This is because such modified rubber simply has improved surface hydrophilicity and hydrophilic groups themselves do not have a function of reacting with and adhering to each other.

Modified rubber treated with the silane-coupling agent can be used for tire formulations in such a manner that the modified rubber is dispersed in fresh rubber, thereby preparing a tire formulation containing a large amount of waste rubber. In this case, the surface-modified rubber is processed into powder having a particle size of 1 μm to 3 mm. When the particle size is less than 1 μm, vulcanized rubber has a large surface area and therefore a large amount of silane-coupling agent must be used for treatment. Furthermore, cost for reducing the particle size is increased. Thus, such a size is not fit for this application. In contrast, when the particle size is more than 3 mm, the vulcanized rubber has such an excessively large size that the workability of the tire formulation during production is lowered. Modified rubber that is not treated with the silane-coupling agent does not lend itself to this application in the same reason as that of the elastic form application. This is because hydrophilic groups themselves on the surface do not participate in a crosslinking reaction and therefore the adhesiveness is not almost improved.

The present invention will now be described with reference to examples.

### EXAMPLES 1-7 AND COMPARATIVE EXAMPLE 1

1. Sample Preparation

Samples of Examples 1-4 were prepared according to the following procedure.

Crushed rubber (manufactured by Muraoka Rubber Reclaiming Co., Ltd.) including waste rubber chips having a size of 2 to 5 mm was surface-treated with diluted surface-treating agents (silane-coupling agents A-C, wherein agent A represents mercaptopropylsilane (A-189, manufactured by Nihon Unicar Co., Ltd.), agent B represents glycidoxypropylsilane (A-403, manufactured by Shin-Etsu Chemical Co., Ltd.), and agent C represents aminopropylsilane (A-903, manufactured by Shin-Etsu Chemical Co., Ltd.)), shown in Table 1 below. The treating agents were diluted according to the following procedure: 5% of each treating agent was mixed with 95% of diluent (ethyl acetate) for 3 minutes. Subsequently, 100 g of the rubber chips were dipped in 200 g of the treating dilution, and the resulting dilution was mixed for 1 to 2 minutes and then allowed to stand for 48 hours. The resulting dilution was sieved, and the obtained chips were dried in a draft for 4 hours or more.

On volume basis, 80% of the resulting waste rubber chips and 20% of a resin binder (Takenate F-179-5, manufactured by Mitsui Takeda Chemicals, Inc.) were mixed at room temperature for about 5 minutes. The resulting mixture was formed into strips having a thickness of 10 mm, a width of 25 mm, and a length of 160 mm. The resulting strips were then dried at room temperature (at 20° C. for 48 hours) or at higher temperature (at 115° C. for 45 minutes), thereby obtaining samples of each example. For Comparative Example 1, other samples were prepared using untreated waste rubber chips.

2. Performance Evaluation Test

The samples of the examples and the comparative example were subjected to a durability test in a 60° C. wet-heat oven (the samples were hot-dipped). The samples before the test, the samples dipped for 3 days, the samples dipped for 7 days, and the samples dipped for 21 days (deterioration in durability) were evaluated about adhesiveness. In the adhesiveness evaluation, the breaking strength (kgf) and the breaking elongation (mm) were measured with a testing machine, Instron 5000, at a stretching rate of 50 mm/min. Obtained measurements were converted into index values by normalizing the initial adhesive strength of the sample of Comparative Example 1 to an index value of 100. A larger value represents higher performance.

The results are summarized in Table 1 below.

TABLE 1

| | Exam- | Exam- | Exam- | Exam- | Comparative |
|---|---|---|---|---|---|
| | ple 1 | ple 2 | ple 3 | ple 4 | Example 1 |
| Rubber Chip | 80 | 80 | 80 | 80 | 80 |
| (Volume %) | | | | | |
| Surface- | A | B | C | A | None |
| Treating Agent | | | | | |
| Content (%) | 5 | 5 | 5 | 5 | — |
| Binder | 20 | 20 | 20 | 20 | 20 |
| (Volume %) | | | | | |
| Initial | 220 | 140 | 140 | 185 | 100 |
| Adhesive | | | | | |
| Strength | | | | | |
| Adhesive | 215 | 185 | 160 | 215 | 70 |
| Strength | | | | | |
| (After 3 Days) | | | | | |
| Adhesive | 215 | 190 | 140 | 200 | 40 |
| Strength | | | | | |
| (After 7 Days) | | | | | |
| Adhesive | 200 | 170 | 115 | 200 | 40 |
| Strength | | | | | |
| (After 21 Days) | | | | | |
| Drying | High | High | High | Room | Room |
| Condition | Tempe- | Tempe- | Tempe- | Tempe- | Tempe- |
| | rature | rature | rature | rature | rature |

As shown in Table 1, the samples of Examples 1-4, which are treated by the silane-coupling agents according to the present invention, have significantly improved adhesive strength in an initial state and after the deterioration. In the sample of Comparative Example 1, which is not surface-treated, the adhesive strength is significantly decreased due to the deterioration. For the drying condition, the samples dried at high temperature have an adhesive strength larger than that of the samples dried at room temperature in an initial state. For the type of the silane-coupling agent, silane-coupling agent A having a mercapto group is the most effective in improving the adhesive strength, and silane-coupling agent B having a glycide group is secondly effective. Furthermore, silane-coupling agent A having a mercapto group is excellent in stability after the deterioration.

Next, silane-coupling agent A was diluted to prepare 3%, 1%, 0.5% solutions. The samples were treated with these solutions and then evaluated about adhesiveness in an initial state and after the samples were subjected to the deterioration (after 21 days) in the same manner as the above. The results are shown in Table 2 together with the results of Example 4 and Comparative Example 1.

TABLE 2

| | Exam- | Exam- | Exam- | Exam- | Comparative |
|---|---|---|---|---|---|
| | ple 4 | ple 5 | ple 6 | ple 7 | Example 1 |
| Rubber Chip | 80 | 80 | 80 | 80 | 80 |
| (Volume %) | | | | | |
| Surface- | A | A | A | A | — |
| Treating Agent | | | | | |
| Content (%) | 5 | 3 | 1 | 0.5 | — |
| Initial | 185 | 200 | 215 | 190 | 100 |
| Adhesive | | | | | |
| Strength | | | | | |
| Adhesive | 200 | 190 | 185 | 160 | 40 |
| Strength | | | | | |
| (After 21 Days) | | | | | |
| Drying | Room | Room | Room | Room | Room |
| Condition | Tempe- | Tempe- | Tempe- | Tempe- | Tempe- |
| | rature | rature | rature | rature | rature |

As shown in Table 2, when the treating agent has a content of 0.5 to 5%, especially 1 to 3%, the rubber chips have highly improved adhesiveness.

### EXAMPLES 8-12 AND COMPARATIVE EXAMPLES 2-5

1. Material

The following materials were used for preparing the samples of examples and comparative examples.

(1) Waste Vulcanized Rubber (Product Manufactured from used TBR Tires by Muraoka Rubber Reclaiming Co., Ltd.)

Waste Rubber X: grade 2050, a particle size of 2 mm to 5 mm (Examples 1 and 2 and Comparative Examples 1 and 2)

Waste Rubber Y: grade 10 TB, a particle size of 50 μm to 2 mm (Example 3 and Comparative Examples 3 and 4)

(2) Silane-Coupling Agent

KBM403, manufactured by Shin-Etsu Chemical Co., Ltd.

(3) Matrix Material

Urethane: a moisture-curing urethane compound manufactured by Nihon Polyurethane Industry Co., Ltd.

Tire Rubber: Composition shown in Table 3 below.

TABLE 3

| | Part by Weight |
|---|---|
| Natural Rubber | 100 |
| Carbon Black (ISAF) | 45 |
| Stearic Acid | 1.5 |
| Anti-aging Agent (RD*) | 1 |
| Hydrozincite | 3 |
| Rubber Accelerator (NOBS**) | 2 |
| Sulfur | 2 |

*RD: 2,2,4-trimethyl-1,2-dihydroquinoline
**NOBS: N-oxydiethylene-2-benzothiazolyl-sulfenamide

2. Corona Discharge Treatment of Waste Rubber

In Examples 8-10, corona discharge treatment was performed according to the following conditions: an output power of 10 W/cm (an electric power consumption per centimeter of 10 W) and a treating time of 1 minute for one pass. In Examples 11 and 12, the corona discharge treatment was performed according to the following conditions: an output power of 5 W/cm and a treating time of 30 seconds and 1 minute, respectively. Thereby, the contact angles shown in Tables 4 and 5 were obtained. In Comparative Examples 3 and 5, the corona discharge treatment was performed with an small output power of 0.3 W/cm for a short treating time of 3 such that the contact angle exceeds 80 degrees, as shown in Tables 4 and 5. In the measurement of the contact angle, distilled water was dropped on the sample surface and the contact angle was immediately measured. Every sample was treated, allowed to stand for about 5 minutes, and then treated again under the same conditions as those of the former treatment (a number of times of treatment is two). In Comparative Examples 2 and 4, the corona discharge treatment was not performed.

3. Treatment with Silane-Coupling Agent

Next, only the samples of Examples 9-12 were treated with a silane-coupling agent. The mixing ratio of the waste rubber to the silane-coupling agent was 100 to 1 on weight basis. The silane-coupling agent was dissolved in ethyl acetate to prepare a 5% solution on weight basis. The waste rubber, which was corona-treated, was mixed at room temperature with a Henschel mixer, and the silane-coupling agent solution was dropped in the resulting mixture during the mixing to perform uniform surface-treatment.

4. Dispersion in Matrix

The waste rubber was dispersed in each matrix such that the waste rubber has a content of 20% by volume. In Examples 8 and 9 and Comparative Examples 2 and 3, the waste rubber was rapidly mixed with the urethane compound, which is the matrix, before a curing step. In Examples 10-12 and Comparative Examples 4 and 5, the waste rubber was mixed with the tire rubber, which is the matrix, with a roller heated at 60° C.

5. Sample Preparation

After mixing, each mixture containing the urethane compound and the waste rubber was formed into strips having a width of 15 mm, a thickness of 8 mm, and a length of 10 cm. A tire formulation was pressed at 150° C. for 30 minutes to form vulcanized rubber.

6. Performance Evaluation Test

The breaking strength of the prepared samples of Examples and Comparative Examples was measured with a tensile testing machine at a stretching rate of 20 mm/min and a distance between chucks of 50 mm. The measurement was conducted three times for each sample and the average was employed.

The results are summarized in Table 4 (waste rubber X and a urethane matrix) and Table 5 (waste rubber Y and a tire rubber matrix). The breaking strength shown in each table is an index value, which is obtained by normalizing the breaking strength of the samples of Comparative Example 2 or 4 to an index value of 100.

TABLE 4

| | Comparative | Comparative | | |
|---|---|---|---|---|
| | Example 2 | Example 3 | Example 8 | Example 9 |
| Corona | Not | Performed | Performed | Performed |
| Treatment | Performed | | | |
| Corona- | — | 0.3 W/cm | 10 W/cm | 10 W/cm |
| Treatment Power | | | | |
| Corona- | — | 3 seconds | 1 minutes | 1 minutes |
| Treatment Time | | | | |
| Contact Angle | 114 | 96 | 37 | 39 |
| (degree) | | | | |
| Treatment with | Not | Not | Not | Performed |
| Silane-coupling | Performed | Performed | Performed | |
| Agent | | | | |
| Breaking | 100 | 124 | 303 | 328 |
| Strength | | | | |

TABLE 5

| | Comparative | Comparative | Exam- | Exam- | Exam- |
|---|---|---|---|---|---|
| | Example 4 | Example 5 | ple 10 | ple 11 | ple 12 |
| Corona | Not | Performed | Per- | Per- | Per- |
| Treatment | Performed | | formed | formed | formed |
| Corona- | — | 0.3 W/cm | 10 | 5 W/cm | 5 W/cm |
| Treatment | | | W/cm | | |
| Power | | | | | |
| Corona- | — | 3 seconds | 1 | 30 | 1 |
| Treatment | | | minutes | seconds | minutes |
| Time | | | | | |
| Contact | 114 | 96 | 39 | 78 | 62 |
| Angle | | | | | |
| (degree) | | | | | |
| Treatment | Not | Not | Per- | Per- | Per- |
| with | Performed | Performed | formed | formed | formed |
| Silane- | | | | | |
| Coupling | | | | | |
| Agent | | | | | |
| Breaking | 100 | 102 | 262 | 173 | 210 |
| Strength | | | | | |

As shown in Tables 4 and 5, the samples of the examples, which are corona-treated so as to have a contact angle of 80 degrees or less and treated with the silane-coupling agent depending on applications, have a large breaking strength, because the rubber surface has adhesiveness. That is, the following advantages can be confirmed: (1) surface-modified rubber obtained by corona-treating waste vulcanized rubber has high adhesiveness to the urethane compound and (2) the surface-modified rubber has high adhesiveness to tire rubber when the surface-modified rubber is further treated with the silane-coupling agent after the corona discharge treatment.

### INDUSTRIAL APPLICABILITY

As described above, the present invention provides a process for producing surface-modified rubber having inexpensiveness and elastic properties inherent in waste vulcanized rubber. Such surface-modified rubber can be effectively used for elastic forms, tire formulations, paving materials, and paving courses.

Furthermore, the present invention provides surface-modified rubber having adhesiveness higher than ever, wherein the surface-modified rubber is corona-treated such that the surface has a contact angle smaller than a predetermined value. Thus, the present invention provides techniques that are useful for effectively material-recycling the waste vulcanized rubber resulting from used tires and so on. The present invention is useful for manufacturing elastic forms from the waste vulcanized rubber, useful for recycling the waste vulcanized rubber into tires, and useful for preparing recycled-rubber formulations for pavement.

1. A process for producing surface-modified rubber comprising a step of dipping waste vulcanized rubber in a silane-coupling agent diluted with a solvent.

2. The production process according to claim 1, wherein the content of the diluted silane-coupling agent is 0.5 to 5%.

3. The production process according to claim 1 or 2, wherein the silane-coupling agent has a mercapto group.

4. The production process according to claim 1 or 2, wherein the silane-coupling agent has an S—S bond.

5. An elastic form manufactured by molding surface-modified rubber, produced by the production process according to claim 1, into one piece by heat compression.

6. A tire formulation comprising powdery surface-modified rubber dispersed in fresh rubber, wherein the powdery surface-modified rubber, produced by the production process according to claim 1, has a particle size of 1 μm to 3 mm.

7. A paving material comprising a hard aggregate, an elastic aggregate, and a binder, wherein the elastic aggregate contains surface-modified rubber, produced by the production process according to claim 1, having a particle size of 10 μm to 20 mm.

8. A paving course comprising a hard aggregate, an elastic aggregate, and a binder, wherein the elastic aggregate contains surface-modified rubber, produced by the production process according to claim 1, having a particle size of 10 μm to 20 mm.

9. A process for producing surface-modified rubber comprising a step of modifying the surface of vulcanized rubber such that the surface has a contact angle of 80 degrees or less.

10. The production process according to claim 9, wherein the surface-modifying step includes the corona discharge treatment of the vulcanized rubber surface.

11. The production process according to claim 9 or 10 further comprising a step of treating the vulcanized rubber surface, surface-modified in the surface-modifying step, with a silane-coupling agent.

12. A paving material containing a binder, an aggregate, and surface-modified rubber, produced by the production process according to claim 9, having a particle size of 10 μm to 20 mm.

13. A paving course containing a binder, an aggregate, and surface-modified rubber, produced by the production process according to claim 9, having a particle size of 10 μm to 20 mm.

14. An elastic form manufactured by molding surface-modified rubber, produced by the production process according to claim 11, into one piece by heat compression.

15. A tire formulation comprising powdery surface-modified rubber dispersed in fresh rubber, wherein the powdery surface-modified rubber, produced by the production process according to claim 11, has a particle size of 1 μm to 3 mm.
